(19) United States
(12) Patent Application Publication
(10) Pub. No.: US 2008/0176050 A1
(43) Pub. Date: Jul. 24, 2008

(54) Gypsum wallboard facings

(75) Inventors: Timothy Scott Lintz, Waterford, NY (US); James R. Gleason, Niskayuna, NY (US)

Correspondence Address: BIRCH STEWART KOLASCH & BIRCH, PO BOX 747, FALLS CHURCH, VA, 22040-0747, US

(73) Assignee: Lydall, Inc., Manchester, CT (US)

(21) Appl. No.: 11/987,671

(22) Filed: Dec. 3, 2007

Related U.S. Application Data
(60) Provisional application No. 60/868,132, filed on Dec. 1, 2006.

(51) Int. Cl. B32B 13/14; B32B 5/02; B32B 33/00

(52) U.S. Cl. 428/213; 428/317.7; 428/219; 428/294.7

(57) ABSTRACT

The invention provides an improved facing (1) for a gypsum wallboard (22) that has a single layer (2) of nonwoven substrate (3) having about 40-80% of glass staple fibers (4) and about 50-15% of polymeric fibers (5), and wherein the ratio of the diameters of the glass fibers (4) and the polymeric fibers (5) is between about 1.5-3:1. A hydrophilic binders is disposed in the substrate (3) in the form of a porous film (10) that extents throughout the substrate (3) so as to provide the substrate, having only the binder therein, with a porosity of between about 150-450 cfm/sq. ft. A hydrophobic, polymeric coating (6) is applied to an upper front face (7) of the substrate (3), wherein 90% of the coating (6) lies within a distance from the front face (7) of the substrate (3) that is no more than 50% of the thickness (T) of the substrate (3).

The present invention relates to facings for gypsum wallboards, and more particularly to such facings and wallboards of exterior grade.

### BACKGROUND OF THE INVENTION

Gypsum wallboards have facings on each of the flat parallel sides of the wallboards. The facings are, generally, referred to as the front facing and the back facing, since the two facings may be quite different. The so-called front facing is normally the facing intended to have utilitarian purposes, which, among others, is that of forming a decorative coating, an abuse resistance surface or providing a moisture and water barrier. The back facing is primarily for protection for the gypsum core of the wallboard and dimensional stability. The present invention relates more specifically to such facings that are of such a protective nature that the wallboards may be used in exterior applications.

In this regard, wallboards have increasingly replaced exterior grade plywood, particleboard, and the like, as an exterior sheathing for structures, e.g., houses, buildings, et cetera. These exterior grade wallboards are intended to be a weather barrier, although not the primary weather barrier. For example, after the exterior grade wallboards are placed on an outside wall of a structure, the wallboards then receive a facade of more conventional building materials such as wood, brick, cinderblock, siding and the like, which serves as the primary weather barrier. While the primary weather barrier will be a substantial structure, the exterior grade wallboard must, nonetheless, be resistant to weather. This is because that wallboard must remain intact while the structure is being constructed, e.g., during the process of erecting a building and, in addition, must prevent water and the like, which might penetrate openings in the primary weather barrier, from deteriorating the gypsum core of the wallboard.

Generally speaking, exterior grade wallboards have thick, relatively heavy basis weight facers that usually include surface coatings (have a substantial coating on the front or exterior side of the facing) so as to provide to the facing and, hence, to the wallboard, the exterior grade property. The facing itself, generally speaking, is made of moisture resistant fibers, such as glass fibers and polymeric fibers, rather than the conventional cellulosic fibers used as the fibers for facings of interior grade wallboards. In addition, since the exterior grade wallboard may be in position on a structure for some time prior to receiving the primary weather barrier, it is necessary for the wallboard to be water, mildew and UV resistant for a significant length of time, e.g. six months.

For that purpose, some wallboards are not only made of moisture resistant fibers but also use a UV resistant binder to hold those fibers together. US Patent Application 2005/0266225 A1 to Currier et al suggests facings made of a glass fiber mat and an acrylic-type binder, since acrylic-type binders are, by nature, somewhat UV resistant. Following formation of the glass fiber mat with the binder, a coating is applied to one surface thereof, which coating includes an inorganic filler and a polymeric adhesive binder (optionally an inorganic binder). The coating is applied in a quantity sufficient to make the facing essentially impermeable to substantial penetrations of liquid water and moisture. While such a coated facing shows low porosity by the TAPPI T547 air permeability test, the amount of the coating necessary to achieve this result is usually between about at least 30 and up to 60 pounds per thousand square feet (msf) of mat. This results in a very heavy and very costly facing, and the resulting cost of the exterior grade wallboard is high. Ideally, the facing should be between about 7 and 17 pounds per thousand square feet, and the present invention achieves that ideal result.

Another approach is that disclosed in U.S. Pat. No. 7,049,251 B2 to Porter which uses as a facing, a nonwoven, woven or knitted fabric that is quite heavy (e.g., 177 lb/msf in weight and 22 mils thick). The fabric is so tightly structured that the pores of the facing are impermeable to liquid water. The fabric is, however, permeable to water vapor so that the facing may be applied to forming liquid gypsum slurry. During the forming of the wallboard, the tight structure limits penetration of the solidifying slurry into the facing, while allowing drying of the slurry by transmission of moisture though the facing. This latter property is necessary for all acceptable facings. The slurry contacting side of the facing has a coating or saturant which reduces porosity so as to resist slurry penetration and a water repellant material on at least an exterior side of the facing for providing that side of the facing with water repellency to repel rain and water. Facings of that nature, however, require very precise and expensive substrate (fabric) materials, i.e. the tightly structured material, and the resulting wallboard is, again, very expensive.

Another approach is that of U.S. Pat. No. 6,723,670 B2 to Kajander et al, which teaches the use of a glass fiber-containing mat, which may also contain “minor’ (unspecified) amounts of polyester fibers. An aqueous binder, such as an acrylic binder, saturates the mat so that a subsequently applied highly foamed coating is retarded from penetrating into the mat and keeps the coating essentially at the surface of the mat. However, the resulting mat is very heavy, e.g., in actual practice about 22 to 24 pounds per thousand square feet (msf) with a very light coating, for example, 1.6 grams per thousand square feet. This, of course, allows the use of far lesser amounts of the very expensive coating material and, hence, lowers the cost of the coating, but the wallboard is only weakly protected by the coating. This patent also relies on a thick, nonwoven to address control of gypsum slurry penetration during wallboard forming, in conjunction with small coating add-on levels.

A similar approach is that of U.S. Pat. No. 5,883,024, which teaches the use of the combination of glass fibers and synthetic fibers, such as polyester fibers, that are bound together with a resinous adhesive, such as acrylic-based binders and PVC-based binders in relatively high amounts. A coating, which may be the same as the binder, is applied to the facing, with a similar result to that of the preceding patent. Again, heavy weight, thicker facings (15-40 mils) are required.

According, it would be of substantial benefit to the art to provide a facing that is acceptable for exterior grade wallboards, but which does not rely on heavy basis weights of the fiber substrates, which can result in a lack of cut ability or increased fiber irritation, or large amounts of expensive coatings.

### SUMMARY OF THE INVENTION

The present invention is based on several primary and several subsidiary discoveries.

First of all, from the above brief description of the prior art, it can be appreciated that it is important to make the substrate of the facing as dense as possible so as to limit the amount of expensive coating material necessary to seal the surface of the facing against weather and also limit the penetration of gypsum slurry though the facing during gypsum board manufacture. In the present invention the coating both reinforces a very lighter weight nonwoven substrate to provided required properties and aids in controlling the penetration of gypsum slurry into the substrate during manufacture of the wallboard. Stated another way, the art has appreciated that a dense substrate limits the penetration of the coating into the substrate and, thus, allows sealing of the facing at the exterior surface thereof with lower amounts of the expensive coatings. Further, as briefly noted above, the approaches in the art have been that of making thick, dense facing substrates, such as by weaving, knitting, and the like, or by saturating the substrate with a binder to limit penetration of the coating into the substrate or by foaming the coating so as to limit the penetration of the coating in the substrate. However, as noted above, all of these efforts have not produced a coated facing where the amounts of coating required to seal the surface of the facing are reduced to the point that the facing is substantially reduced in cost, and yet provides adequate weather protection and limits the penetration of the gypsum slurry into the substrate during manufacture of the wallboard.

The present invention solves these difficulties by a combination of several features. First, the present invention densifies the substrate by using combinations of staple fibers of substantially different diameters. It is known that particles can be more densely packed by using particles of different sizes, and it has been found that that same principal can be applied to the packing of fibers. For example, it has been found that when the ratio of diameters of different diameter fibers is between about 1.5-3:1 or more especially between about 11-16: 6-8, there is sufficient packing of the combination of fibers that a substrate of such density is prepared that the substrate, with that increased density, will substantially impede the penetration of a coating thereinto, while providing the required strength for the gypsum board to be processed in the usual manners and give good weather protection. This is a very inexpensive way of densifying the facing substrate. Further, since the facing is to be used for exterior grade wallboards, the invention uses a combination of fibers that are moisture and mildew resistant. Thus, the invention uses a combination of staple glass fibers and polymeric staple fibers of substantially different diameters. Glass staple fibers provide good water resistance and staple polymeric fibers can pack well in and among the glass staple fibers when the substrate is composed of about 50 to 80% of glass staple fibers and about 50-15% of polymeric staple fibers. In this latter regard, it has been found that the small deniers and shorter chop lengths are necessary to permit fold-over of the facing during wallboard manufacture to provide faced wallboard edges. At substantially higher deniers and chop lengths, “springback” of the facing at the sides of the gypsum boards is liable to occur and that is not acceptable. For this reason, the prior art has limited the amount of polymeric fibers, especially polyester fibers, used in facings. Of course more that two fibers of different diameters and chop lengths may be used, but two different diameters and chop lengths are sufficient. These differences in diameters are the average differences, and individual differences may vary more widely.

As another feature of the invention, the binder used in the present substrate of the facing is a hydrophilic binder and that binder is disposed in the substrate in the form of a porous film that extends in all directions throughout the substrate and bridges pores of the substrate. Since the binder is hydrophilic, it will allow penetration of the forming gypsum slurry into the substrate as the wallboard is being formed so as to firmly lock the substrate, and thus, the facing, to the hardened gypsum core. However, as noted above, it is important that the gypsum core not penetrate into the substrate of the facing more than that necessary to get a good lock of the substrate of the facing to the forming gypsum core. Otherwise, this can, at worst, result in gypsum bleedthrough to the surface of the facer, or simply increase the weight of the overall board without any advantage and the disadvantage of greater weight and cost. To achieve this result, the binder is in the form of a porous film that bridge pores of the substrate so as to provide the substrate, with the binder therein, with an air porosity of between about 150 and 450 cubic feet per minute per square foot. With this porosity, the hydrophilic binder will allow sufficient penetration of forming gypsum slurry to bind well to the facing, but not penetrate unduly into the facing. In the prior art, the binders are usually disposed at the interstices of the fibers so as to provide maximum locking of the fibers together with a minimum amount of binders.

As a further primary feature of the invention, the facing has a hydrophobic polymer coating applied to a front face of the substrate. The hydrophobic coating not only increases the resistance to water penetration, so as to make the facing suitable for exterior grade wallboards, but also further limits penetration of the forming gypsum slurry into the facing.

As a further primary feature of the invention, it is found that the penetration of the coating into the substrate should be such that 90% of the coating lies within a distance from the front face of the substrate that is approximately 50% of the thickness of the substrate. By limiting the coating to essentially the upper half of the substrate, the amount of coating necessary to achieve sufficient water resistance to the surface of the facing is very substantially decreased, and thus, the cost of the facing and the resulting wallboard is substantially decreased.

As a further subsidiary feature, the coating may be applied as a foam that, when dried, collapses into a coating that is permeable to water vapor. A coating that is not permeable to water vapor considerably extends the drying time of a wallboard during manufacture and is highly undesirable.

Thus, briefly stated, the present invention provides a facing for a gypsum wallboard where the facing is a single layered, non woven substrate having about 40-80% of glass staple fibers and about 50-15% of polymeric staple fibers, and wherein the ratio of the diameter of the glass fibers and polymeric fibers is between about 1.5-3:1, especially, 11-16:6-8.

A hydrophilic binder is disposed in the substrate in the form of a porous film that extends throughout the substrate and bridges pores of a substrate so as to provide the substrate, having only the binder therein, with a porosity of between about 150-450 cubic feet per minute (cfm)/sq. ft.

A hydrophobic polymeric coating is applied to an upper front face of the substrate wherein 90% of the coating lies within a distance from the front face of the substrate that is approximately 50% of the thickness of the substrate.

### BRIEF DESCRIPTION OF THE DRAWINGS

FIG. 1 is a highly idealized diagrammatic illustration of a side view of the present facing;

FIG. 2 is a highly idealized diagrammatic illustration of a side view of the facing showing penetration of gypsum from a forming gypsum wallboard in the lower portion thereof;

FIG. 3 is a diagrammatic illustration of an apparatus for producing the present facing; and

FIG. 4 is a diagrammatic illustration of an apparatus for applying the coating of the invention to the facing.

### DETAILED DESCRIPTION OF THE INVENTION

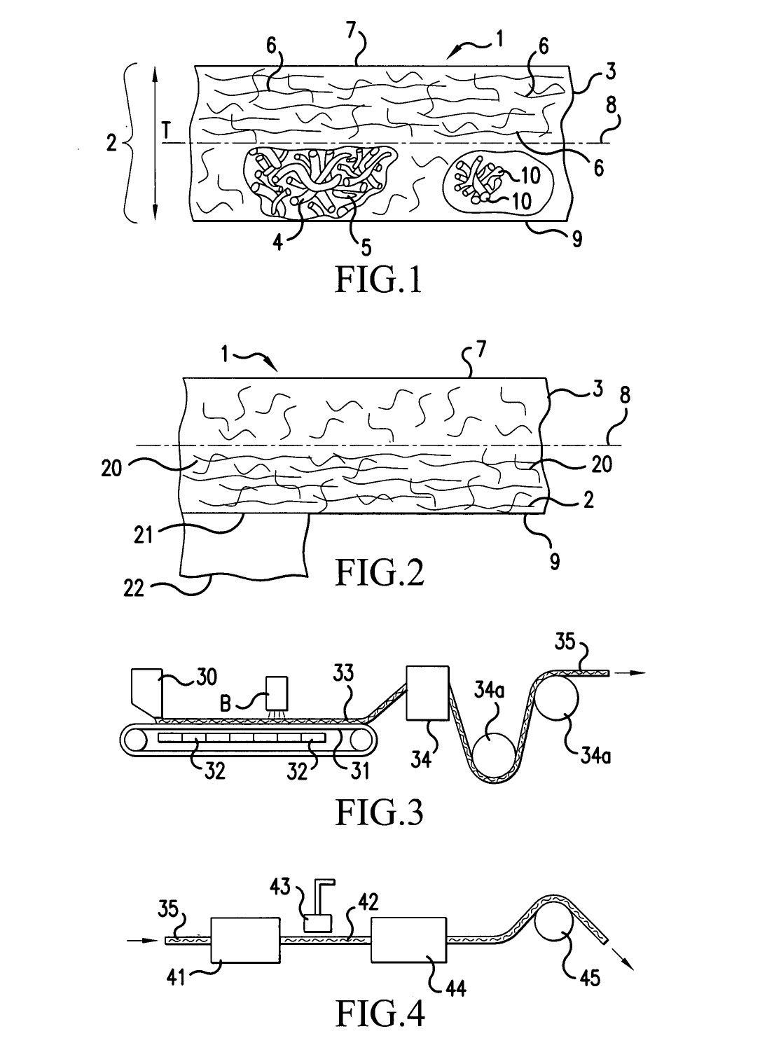

As can best be seen from FIG. 1, the present facing, generally, 1 of the gypsum wallboard is made of a single layer, generally, 2 of a nonwoven substrate 3 having about 40-80% of glass staple fibers 4 (shown in an enlarged partial section) and about 50-15% of polymeric staple fibers 5. The ratio of the diameters of the glass fibers 4 to the polymeric fibers 5 is at least about between 1.5-3:1, but preferably is between about 11-16:6-8. As can be understood from the following explanation, those diameters could be reversed and there may be more than two different fibers with significantly different diameters.

In this latter regard, the purpose of the different diameters is to achieve dense packing of the fibers. As briefly noted above, fibers will pack more densely in the substrate when the fibers have significantly different diameters. Smaller diameter fibers will enmesh into the array of larger diameter fibers, as diagrammatically shown in FIG. 1, and, hence, the density of the total substrate is substantially increased. It will also be quite apparent that more than two different diameters of fibers may be used, but it has been found that only two different fiber diameters are require to achieve sufficient density of the substrate so as to promote the dispositions of the coating at near the surface of the densified substrate, especially when the fibers are in certain ratios, as explained above, and further especially when the fibers are of certain compositions.

In this latter regard, preferably the larger diameter fibers are staple glass fibers with an average length of about 0.5 to 3 inches, preferably about 0.75 to 1.25 inches, an average diameter of about 5 to 30 microns, e.g., 11 to 18 and most preferably about 16 microns. The smaller diameter fibers are polymeric fibers, especially polyester fibers, having an average denier of about 0.1 to 2 deniers, especially about 0.5 denier, with as average length of about 0.1 to 0.5 inches, especially about 0.25 inch. This could be reversed, but the packing density will suffer somewhat because the more flexible polymeric fibers better enmesh into the glass fibers. Further, as noted above, longer lengths of the polyester fibers could cause “springback”. A workable ratio of diameters is about 1.5-3:1, most preferably about 11-16:6-8, and especially about 2:1 of glass fibers to polymeric fibers. Good substrates are provided when the diameters of the larger diameter fibers are about 11-20 microns and the smaller diameter fibers have diameters of about 4 to 10, e.g., 6-10, especially, 6 to 8 microns. In a most preferred embodiment, the large diameter fibers are glass fibers of about 16 microns and the smaller diameter fibers are polyester fibers of about 8 microns, although other polymeric fibers such as polyolefins, vinyl, nylon and acetate fibers could be used. Polyester fibers pack well, are mildew resistant, and are, therefore, preferred. In addition, it is preferred that the total weight of the uncoated nonwoven substrate is about 7-14 lbs/msf (34 to 68 grams per square meter).

Turning again to FIG. 1, the substrate 3 has a coating 6 therein and as can be seen from the dashed horizontal lines illustrating the coating in FIG. 1, the density of the coating along the thickness T of the substrate decreases from an upper front face 7 to a centerline 8. As further illustrated by the horizontal dashed lines, the coating is disposed within substrate 3 such that 90% of the coating 6 lies within a distance from the front face 7 of the substrate 3 that is no more than approximately 50% of a thickness T of the substrate 3. By this arrangement, most of the coating is congregated at or near the front face 7 so that the greater density of the coating 6 is at or near the front face 7. This will also avoid fiber irritation to field workers, and will form a substantial water barrier, with the hydrophobic agent therein, even when the total amount of the coating 6 in the substrate 3 is relatively low. This allows the present facing to achieve the desired properties of exterior grade wallboard with thinner facings due to the fiber packing and the controlled coating penetration, which results in a much-reduced cost of the wallboard. Indeed, with the present invention, the weight of the coating can be as little as about 7-10 lb/msf (34-51 g/sq m) and still provide high water resistance to the facing. Such low amounts of coating, in addition, allows the total weight of the facing to be substantially reduced, and the total weight of the facing, including the coating, can be from about 7-26 lbs./1000 sq. ft. (20 to 80 lbs. per 2880 sq. ft.—a common unit of measurement used in the art).

With the above-discussed differences in diameters of the fibers making a highly packed substrate, the penetration of the coating into the substrate will be substantially decreased, as discussed above, and most of the coating will lie at or near the front face 7 where it can be more effective in providing the water barrier. However, as also noted above, the binder is in the form of a porous film 10 throughout the substrate (shown in the enlarged partial section) and plays an important part in limiting penetration of the coating into the substrate. The binder, in conjunction with the fiber packing, also helps to control the penetration of the coating into the substrate by adjusting the porosity of the substrate. For this purpose, the porosity of the substrate with the porous film binder therein should be between about 150-450 cubic feet per minute per sq foot, although it is preferably for this purpose that the porosity of the substrate is from about 30-100 cfm/sq. ft., as measured by the TAPPI T547.

Further, in part, the penetration of the coating into the substrate can be controlled by the density and viscosity of the coating material itself. For this purpose, the coating may contain a densifying and viscosity-increasing agent, such as inorganic filler, and the coating may contain about 30-80%, especially about 40-70% of the inorganic filler. Further, the coating may contain, in addition to the conventional hydrophobic agent, e.g., a silicone or a fluorochemical, at least one member selected from the group consisting of conventional ultraviolet light inhibitors and antimicrobial agents. Very small total amount of these may be used and thus, be relatively inexpensive, since the coating can be used in small amounts and still effect weather resistance, as noted above. This is particularly true when an inorganic filler is used, as discussed above, and particularly when the inorganic filler is selected from the group consisting of clay, calcium carbonate, talc, mica, alumina trihydrate and Kaolin.

The particular polymer of the coating has an effect on the weather resistance of the coating and for this reason the polymer of the coating is preferably selected from the group consisting of acrylic, styrene acrylic, vinyl acrylic, vinyl acetate, ethylene vinyl acetate, styrene butadiene rubber, polyvinylchloride, polyesters and urea or phenol or melamine formaldehyde. Preferably, the polymer of the coating is an acrylic polymer.

In addition, while the coating may be applied by a variety of methods, such as by rolls, doctor blades, sprayers and the like, penetration of the coating can be further controlled by the mode of applying the coating to the substrate. A preferred method is that of applying the coating as a foamed coating, e.g., with a blow ratio of 6-2:1 air/coating, so as to form a collapsed foamed coating, as discussed more fully below.

It is the combination of the above discussed features of the invention that provide a coating on the substrate where 90% of the coating lies within approximately 50% of the thickness of the substrate, and, hence, allows the use of substantially reduced amounts of the coating. Further, with the coating being in the upper 50% of the substrate, the coating will also form something of a barrier to penetration of forming gypsum slurry when the facing is applied to the forming gypsum slurry in a conventional manner. As briefly noted above, it is important that the gypsum slurry penetrate into the back face 9 of the substrate 3 so as to firmly lock the facing to the formed gypsum. Further as noted above, to promote that penetration, the binder is a hydrophilic binder. However, as also noted above, that penetration of forming gypsum slurry should not be too great, and for that reason the coating is a hydrophobic coating, which will impede the penetration of the gypsum into the upper 50% of the substrate. As a result of these features, the gypsum slurry penetrates the back face 9 of the substrate 3 in such a manner that there is a decreasing portion of the gypsum. As diagrammatically shown in FIG. 2, as the gypsum 20 approaches center line 8, decreasing amounts of gypsum 20 are contained in the substrate. This will give a good lock of the facing onto the gypsum board, but will not allow excessive amounts of the gypsum to penetrate the substrate 3 and unduly and unnecessarily increase the weight of the wallboard.

The hydrophilic binder, disposed in the substrate in the form of a porous film 10, also effects the penetration of the forming gypsum into the substrate. The binder may be the same composition as the coating and is preferably selected from the group as set forth above in connection with the coating. However, it is preferred that the binder is selected from the group consisting of acrylic, styrene acrylic, vinyl acrylic, vinyl acetate, epoxy and polyester polymers. An acrylic binder is preferred because it functions well and is by nature hydrophilic. When the others are used they should have included therein a conventional hydrophilic agent, e.g., a surface-active agent. The weight of the binder in the substrate is preferably an amount of between 20-40% of the weight of the substrate. This combination, especially when the binder is an acrylic polymer, allows good penetration of the forming gypsum into the substrate, but does not allow excessive amounts to penetrate into the substrate. Nevertheless, the facing is firmly attached to a front face 21 of a gypsum wallboard 22, as shown in FIG. 2. With these arrangements, the gypsum 20 from the wallboard 22 does not substantially penetrate from the wallboard 22 into the facing 1 a distance more than 50% of the thickness of the facing, as shown in FIG. 2.

The facing may be made in a conventional manner by disposing aqueous slurry of glass staple fibers 4 and the polymeric staple fibers 5, along with appropriate control agents, from a head box 30 (see FIG. 3) onto a porous moving belt 31 and dewatering the slurry by water extractors 32 so as to form a web 33. The porous binder film is, preferably formed by a sprayed curtain of binder B that is applied to the web and the web 33 is dried in an oven 34 and/or on a series of cans 34a to form a consolidated and dried web 35. That consolidate and dried web 35, as seen in FIG. 4, is passed to a supplemental dryer 41, if necessary, in order to complete the removal of moisture if that removal is not achieved by the oven and/or cans. A foamed coating 42 is applied from a foaming head 43 and then further dried in secondary radiant heater dryer 44 to collapse the foam into substrate 3, as shown in FIG. 1. Thus, the collapsed foam remains essentially at or near the upper portion of the substrate 3 with the density of the foam in the substrate decreasing from front face 7 to center line 8 so as to provide most of the collapsed foam coating at or near the front face 7. This provides the most effective use of the coating as a barrier to weather and fills voids between fibers near the surface of the facing. A less dense facing would require far more coating to achieve the same result.

### EXAMPLE

In the Example, as well as in the specification and claims, all percentages and ratios are by weight, unless otherwise indicated.

Into a mixer of a conventional papermaking machine is disposed 8 micron diameter/0.25 inch Teijin polyester fibers at a concentration of 0.9% in water. To the mixer is added 0.06% of Milease T dispersant (Clariant Ltd.) and high-speed agitation is continued until a full dispersion is reached (about 10 minutes). Addition water is added to reduce the Milease T to a concentration of about 0.017% and the fiber concentration to about 0.26%. The pH of the dispersion is adjusted to a range of 8.0 to 8.5 with the addition of sodium hydroxide and Rhodameen VP532 dispersant is added to a concentration of 0.05%. Sufficient 1-inch length M glass, M-137 glass fibers (Johns Manville), is added to a concentration of 0.05%, with further high-speed agitation until a full dispersion is reached (about 10 minutes). Thereafter, 10 ppm of 0.15% Nalco 625 polyacrylamide solution (Nalco Corp.) is added with stirring for an addition time (about 5 minutes) to fully disperse the polyacrylamide. This mixture is pumped to the holding tank.

From the holding tank, the mixture is pumped through a fan pump, along with additional water containing a similar concentration Rhodameen VP532 and Nalco 625 from a head box 30 onto the moving screen wire 33 where extractors 32 remove water and the fibers are formed into a nonwoven web 33. The nonwoven web is passed under a sprayed curtain of binder B made of Acronal NX 2835 acrylic polymer latex (BASF Corp.), followed by series of extractors 32 to control the final add-on of the dried binder to about 35% of the dry weight of the total substrate (web and binder) so as to form the porous film. The wet substrate, with the binder therein, is passed though an oven 34 with impinging air at temperatures of about 390 degrees F., and along additional drying cans 34a, if necessary, where it is dried and cured.

A coating, Unibond 1967-3 (Unichem) is prepared. The coating has approximately 66% Kaolin clay, 30% acrylic latex, 0.5% UV inhibitor, 1.0% fluoropolymer, 0.5% of biocide, 1.0% of polyacrylate thickener and 1.0% of Unifroth 0154 (Unichem). The ingredients are mixed with water to provide a 50% solids coating with a viscosity of 10,000 centipoises.

The coating is pumped to a foaming head 43, which has a rotor/stator configuration, and which results in a final blow ratio of 3:1 air:coating. The foam is metered onto the dry nonwoven web (substrate) 35 and knifed to give a controlled penetration into the web at an application rate of 50 grams per square meter (10 lb/msf). Substantially all of the coating lies with in about 50% of the thickness of the web. The coated web is passed under a bank of radiant heaters 44 where the foam collapses to form a water vapor porous film. Additional drying, if necessary, is achieved using can driers 45 that are run at the same conditions as cans 34a, e.g., 60 psi steam pressure to provide temperatures of about 280 to 295 degrees F. The dried and coated facing has a basis weight of about 22.5 lb/msf (110 g/sq. m.).

When the resulting facing was attached to a gypsum board in a conventional manner, the resulting wallboard was water resistance and quite suitable for an exterior grade application.

Accordingly, by the above-described combination of the single layer of substrate, the use of the different diameters of fibers, the hydrophilic binder disposed as a porous film of certain porosities and the hydrophobic polymeric coating in the substrate so that 90% of the coating lies within 50% of the thickness of the substrate, a reduced cost of the exterior grade wallboard is achieved. The resulting product has greatly reduced fiber irritation versus conventional glass-faced gypsum boards. Further, when the binder and coating contain conventional ultraviolet light inhibitors, fire retardants, antimicrobial agents, and the like, as are commonly used in the art, a very weather resistant, exterior grade wallboard is provided. As such, the invention provides a substantial advantage to the art.

What is claimed is:

1. A facing (1) for a gypsum wallboard (22), comprising:
a. A single layered (2) non-woven substrate (3) having about 40-80% of glass stable fibers (4) and about 50-15% of polymeric staple fibers (5), and wherein the ratio of the diameters of the glass fibers (4) and polymeric fibers (5) is between about 1.5-3:1;
b. A hydrophilic binder disposed in the substrate (3) in the form of a porous film (10) that extends throughout the substrate (3) and bridges pores of the substrate (3) so as to provide the substrate, having only the binder therein, with a porosity of between about 150-450 cfm/sq. ft.; and
c. a hydrophobic, polymeric coating (6) applied to an upper front face (7) of the substrate (3), wherein 90% of the coating (6) lies within a distance from the front face (7) of the substrate (3) that is no more than approximately 50% of the thickness (T) of the substrate (3).

2. The facing of claim 1, wherein the ratio is between about 11-16:6-8.

3. The facing of claim 2, wherein the ratio is about 2:1.

4. The facing of claim 3, wherein the larger diameter fibers have diameters of about 11-20 microns and the smaller diameter fibers having diameters of about 6-10 microns.

5. The facing of claim 4, wherein the larger diameter fibers are glass fibers of about 16 microns and the smaller diameter fibers are polyester fibers of about 8 microns.

6. The facing of claim 1, wherein the weight of the fibers in the substrate (3) is about 7-14 lb/msf.

7. The facing of claim 6, where the weight of the coating (6) is about 7-14 lb/msf.

8. The facing of claim 7, wherein the weight of the substrate (3) and coating (6) is about 14-28 lb/msf.

9. The facing of claim 1, wherein the porosity of the substrate (3) is about 300-350 cfm/sq. ft., and the porosity of the coated substrate is about 30-100 cfm/sq. ft.

10. The facing of claim 1, wherein about 50-80% of the coating is inorganic filler.

11. The facing of claim 10, wherein the coating contains at least one member selected from the group consisting of hydrophobic agents, ultraviolet light inhibitors, and antimicrobial agents.

12. The facing of claim 10, wherein the inorganic filler is selected from the group consisting of clay, calcium carbonate, talc, mica, ATH and Kaolin.

13. The facing of claim 1, wherein the polymer of the coating is selected from the group consisting of acrylic, styrene acrylic, vinyl acrylic, vinyl acetate, vinyl chloride and polyester.

14. The facing of claim 1, wherein the coating is a collapsed foam coating.

15. The facing of claim 1, wherein the binder is in the substrate in amounts of between about 20 and 40% of the weight of the fibers in the substrate.

16. The facing of claim 1, wherein the binder is selected from the group consisting of acrylic, styrene acrylic, vinyl acrylic, vinyl acetate, epoxy and polyester polymers.

17. The facing of claim 16, wherein the binder is an acrylic polymer.

18. The facing of claim 16, wherein the binder contains a member selected from the group consisting of ultraviolet light inhibitors, fire retardants, and antimicrobial agents.

19. The facing of claim 1, firmly attached to a front face (21) of a gypsum wallboard (22).

20. The facing of claim 19, wherein gypsum (20) from the wallboard (22) does not substantially penetrate from the wallboard (22) into the facing (1) a distance more than 50% of the thickness of the facing.
